(19) United States
(12) Patent Application Publication
(10) Pub. No.: US 2004/0019802 A1
(43) Pub. Date: Jan. 29, 2004

(54) Method for increasing the security of a CPU

(76) Inventors: Heimo Hartlieb, Graz (DE); Holger Sedlak, Sauerlach (DE); Frauz Klug, Munchen (DE)

Correspondence Address: LERNER AND GREENBERG, P.A., POST OFFICE BOX 2480, HOLLYWOOD, FL, 33022-2480, US

(21) Appl. No.: 10/621,536

(22) Filed: Jul. 17, 2003

Related U.S. Application Data
(63) Continuation of application No. PCT/DE02/00110, filed on Jan. 16, 2002.

(30) Foreign Application Priority Data
Jan. 17, 2001 (DE) 101 01 956.4

(51) Int. Cl. G06F 12/14; G06F 11/30; H04L 9/32; H04L 9/00

(52) U.S. Cl. 713/200

(57) ABSTRACT

A pipeline containing a fetch stage, a decode stage, an execute stage, and a write back stage is used for executing a method that provides a higher level of security to a CPU. The write back stage contains at least one register whose use does not result in any state change of the CPU, and at least one register whose use does result in a state change of the CPU. At least one randomly selected code sequence is inserted in the decode stage as a placeholder code or dummy code sequence, making an attack by DPA more difficult.

### CROSS-REFERENCE TO RELATED APPLICATION

This application is a continuation of copending International Application No. PCT/DE02/00110, filed Jan. 16, 2002, which designated the United States and was not published in English.

### BACKGROUND OF THE INVENTION

### FIELD OF THE INVENTION

The present invention relates to a method for improving the security of a CPU.

Differential power analysis (DPA) is a well-known attack scenario for overcoming built-in security defenses of CPUs. In such an attack, a sequence of program commands and their effects in the CPU are determined by statistical analyses of the characteristics of the power consumption. Detailed conclusions about the executed program can be obtained from these analyses.

Methods are described in Published, Non-Prosecuted German Patent Application DE 199 36 939 A1 and International Publication WO 00/50977 that make a DPA more difficult, in particular for an application in smart cards, by executing, solely for deception purposes, defined processor operations or program steps that are implanted in the program runs on a random selection basis.

### SUMMARY OF THE INVENTION

It is accordingly an object of the invention to provide a method for increasing the security of a CPU that overcomes the above-mentioned disadvantages of the prior art methods of this general type.

With the foregoing and other objects in view there is provided, in accordance with the invention, a method for increasing security of a CPU containing a pipeline having at least one decode stage and one write back stage. The write back stage has at least one first register whose use does not result in any state change of the CPU, and at least one second register whose use does result in a state change of the CPU. The method includes the steps of inserting at least one randomly selected code sequence that does not cause a state change of the CPU in the decode stage as a placeholder code or a dummy code sequence; and selecting the randomly selected code sequence so as to obtain a program execution time that is different from previous program runs on each run of the specific program.

In the method according to the invention, a CPU structured as a pipeline is used, having at least one decode stage and one write back stage, and typically containing a fetch stage, a decode stage, an execute stage and a write back stage. The write back stage contains at least one register whose use does not result in any state change of the CPU, and at least one register whose use does result in a state change of the CPU. According to the invention at least one randomly selected code sequence is inserted in the decode stage as placeholder code or dummy code sequence. The method can theoretically be used for any pipelines, which in particular can have further stages in addition to the stages specified by way of example, and is explained in more detail with reference to the attached figures.

In accordance with an added mode of the invention, there is the step of reading the randomly selected code sequence from a memory using at least one randomly determined memory address.

In accordance with a further mode of the invention, there is the step of using a ROM as used the memory.

In accordance with another mode of the invention, there is the step of providing the CPU with means for selecting the randomly selected code sequence such that the execution time of the specific program varies with each program run of the specific program.

Other features which are considered as characteristic for the invention are set forth in the appended claims.

Although the invention is illustrated and described herein as embodied in a method for increasing the security of a CPU, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE DRAWINGS

FIG. 1 is a flow diagram of a described pipeline according to the invention; and

FIG. 2 is a schematic diagram of a process of inserting code sequences.

### DESCRIPTION OF THE PREFERRED EMBODIMENTS

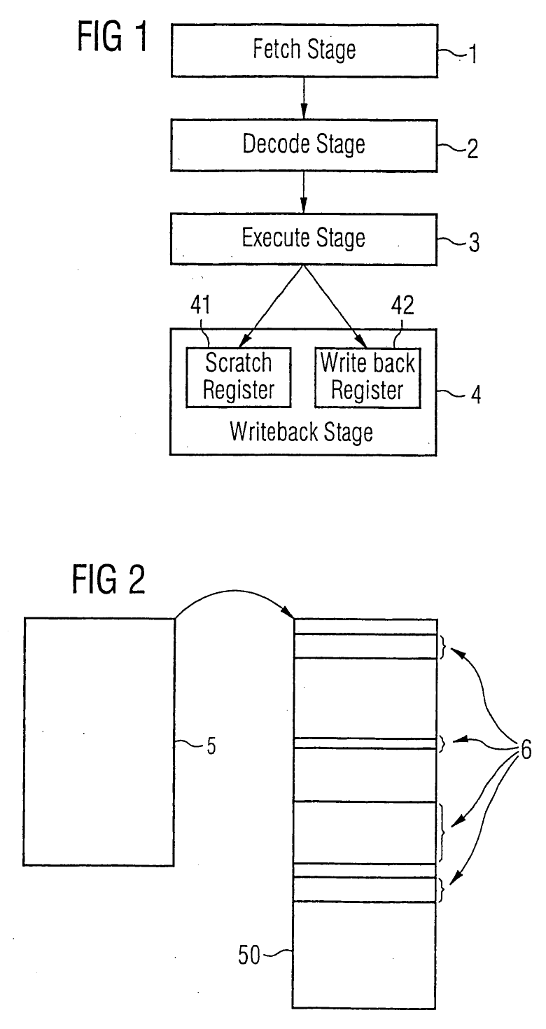

Referring now to the figures of the drawing in detail and first, particularly, to FIG. 1 thereof, there is shown a flow diagram that illustrates a program execution of a pipeline shown as an example, from a fetch stage 1, through a decode stage 2 to an execute stage 3 and from there into a write back stage 4. The write back stage 4 here contains at least a first register 41 as a scratch register 41, and a second register 42 as a write back register 42. The scratch register 41 is a register whose use does not result in any state change of the CPU, while the use of the write back register 42 does result in a state change of the CPU. In order to increase the security of the CPU, a code sequence, in fact theoretically any code sequence, is implanted by the decode stage 2 in the program code transferred in the pipeline. It is also possible to insert a particular additional code sequence at several points in the program code as a placeholder or dummy code sequence. This is shown schematically in FIG. 2.

FIG. 2 shows schematically a code sequence 5 of any program. In the code sequence 5, randomly selected code sequences 6 (dummy sequences) are inserted at various defined or also randomly selected locations, resulting in an expanded code sequence 50. The inserted code sequences 6 can, for instance, be read from a memory, in particular from a ROM.

The individual commands for inserting the code sequences can be generated, for example, by calling addresses produced by a random-number generator. The code sequences to be inserted are read from the memory and transferred to the decoder in random length and order. The decoder implants the code of the dummy code sequences in the running program code (code stream). Even the addresses at which the randomly selected code is implanted in the program code can be determined using a random method known in the art.

No state change of the CPU is caused by the code sequence inserted on a random basis, nor by the plurality of code sequences selected and inserted on a random basis, which solely act as placeholders or dummy code sequences. A key advantage of the method is that the execution time of the actual program code for each run of the same program can be changed as required with respect to the previous runs, thereby making it considerably harder to attempt an attack based on statistical analyses (such as the DPA mentioned in the introduction).

We claim:

1. A method for increasing security of a CPU containing a pipeline having at least one decode stage and one write back stage, the write back stage having at least one first register whose use does not result in any state change of the CPU, and at least one second register whose use does result in a state change of the CPU, which comprises the steps of:
inserting at least one randomly selected code sequence that does not cause a state change of the CPU in the decode stage as one of a placeholder code and a dummy code sequence; and
selecting the randomly selected code sequence so as to obtain a program execution time that is different from previous program runs on each run of the specific program.

2. The method according to claim 1, which further comprises reading the randomly selected code sequence from a memory using at least one randomly determined memory address.

3. The method according to claim 2, which further comprises using a ROM as used the memory.

4. The method according to claim 1, which further comprises providing the CPU with means for selecting the randomly selected code sequence such that the execution time of the specific program varies with each program run of the specific program.
